(19) United States
(12) Patent Application Publication
(10) Pub. No.: US 2019/0042421 A1
(43) Pub. Date: Feb. 7, 2019

(54) MEMORY CONTROL APPARATUS AND MEMORY CONTROL METHOD

(71) Applicant: FUJITSU LIMITED, Kawasaki-shi (JP)

(72) Inventor: Yutaka Tamiya, Yokohama (JP)

(73) Assignee: FUJITSU LIMITED, Kawasaki-shi (JP)

(21) Appl. No.: 16/155,993

(22) Filed: Oct. 10, 2018

Related U.S. Application Data
(63) Continuation of application No. PCT/JP2016/062025, filed on Apr. 14, 2016.

(51) Int. Cl. G06F 12/0804; G06F 7/08

(52) U.S. Cl. CPC G06F 12/0804; G06F 2212/1016; G06F 2212/1032; G06F 7/08

(57) ABSTRACT

A memory control apparatus including at least one buffer memory and a processor coupled to the at least one buffer memory, and the processor configured to execute a process including receiving pieces of data to be written to a memory device, each of the pieces of data being associated with an index indicating a position of memory region of in the memory device, storing the pieces of data to the at least one buffer memory, sorting the pieces of data stored in the at least one buffer memory in accordance with the index, write the pieces of data sorted in the at least one buffer memory to the memory device at once, by using a block access function that writes plural pieces of data each of which the position indicated by the index is included in the predetermined index range.

### CROSS-REFERENCE TO RELATED APPLICATION

This application is a continuation application of International Application PCT/JP2016/062025 filed on Apr. 14, 2016 and designated the U.S., the entire contents of which are incorporated herein by reference.

### FIELD

The embodiments discussed herein are related to a memory control apparatus and a memory control method.

### BACKGROUND

Recently, an application using large-scale array data (array data) such as high-performance computing (HPC) is used for, for example, a finite element method, electromagnetic field analysis, fluid analysis, and the like. For example, an application using such array data is considered to be able to execute further acceleration when an accelerator is implemented by hardware.

For example, in an application of the finite element method targeting tens of millions of elements, calculation is executed by holding array data in a memory device (element), however, in a case of speeding up by a hardware accelerator, reading and writing of the array data are major factors affecting performance.

Various proposals are made as a method for high-speed writing of array data (large-scale array data) and include, for example, methods such as write combining (write combine) and sparse matrix/tiling (block-diagonal matrix).

Examples of the related art include International Publication Pamphlet No. WO2010/035426, Japanese Laid-open Patent Publication No. 2014-093030, and Japanese National Publication of International Patent Application No. 2007-034431.

Another example of the related art includes P. Burovskiy et al., “Efficient Assembly for High Order Unstructured FEM Meshes”, in Field Programmable Logic and Applications (FPL), 2015 25th International Conference on. IEEE, 2015, pp. 1-6, Sep. 2, 2015.

As described above, for example, as a method for high-speed writing of array data, methods such as the write combining and the sparse matrix/tiling are proposed.

In the write combining, data to be written is temporarily stored without being written into a memory device immediately, and then, when other data to be written arrives, if addresses of the other data to be written and the previous data to be written are adjacent to each other, the other data to be written and the previous data to be written are merged (combined) and written collectively to the memory device. However, this write combining has a problem that a probability of the combining decreases as array data becomes larger.

The sparse matrix/tiling is a data representation method for collectively storing only non-zero coefficients in matrix calculation, and is effective for a data reading process, for example, for random access to a stiffness matrix used in the finite element method. However, since an array itself including the non-zero coefficients becomes a dense matrix, it is not suitable for, for example, random access writing.

### SUMMARY

According to an aspect of the embodiments, a memory control apparatus including at least one buffer memory and a processor coupled to the at least one buffer memory, and the processor configured to execute a process including receiving pieces of data to be written to a memory device, each of the pieces of data being associated with an index indicating a position of memory region of in the memory device, storing the pieces of data to the at least one buffer memory, sorting the pieces of data stored in the at least one buffer memory in accordance with the index, write the pieces of data sorted in the at least one buffer memory to the memory device at once, by using a block access function that writes plural pieces of data each of which the position indicated by the index is included in the predetermined index range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of a process by triangle element division in a finite element method application;

FIG. 2 is a diagram schematically illustrating an example of a memory device;

FIG. 3 is a diagram for explaining a problem in the memory device illustrated in FIG. 2;

FIG. 4 is a diagram schematically illustrating a memory control apparatus according to an embodiment;

FIG. 5 is a diagram for explaining an example of the memory control apparatus;

FIG. 6 is a diagram (1) for explaining an example of an algorithm operation of the memory control apparatus in the example illustrated in FIG. 5;

FIG. 7 is a diagram (2) for explaining another example of the algorithm operation of the memory control apparatus in the example illustrated in FIG. 5;

FIG. 8 is a diagram (3) for explaining still another example of the algorithm operation of the memory control apparatus in the example illustrated in FIG. 5;

FIG. 9 is a diagram (4) for explaining further still another example of the algorithm operation of the memory control apparatus in the example illustrated in FIG. 5;

FIG. 10 is a diagram (5) for explaining further still another example of the algorithm operation of the memory control apparatus in the example illustrated in FIG. 5;

FIG. 11 is a diagram for explaining an example of a distribution process of the memory control apparatus in the example illustrated in FIG. 5;

FIG. 12 is a diagram (1) for explaining an effect of a memory control apparatus of an example; and

FIG. 13 is a diagram (2) for explaining another effect of a memory control apparatus of an example.

### DESCRIPTION OF EMBODIMENTS

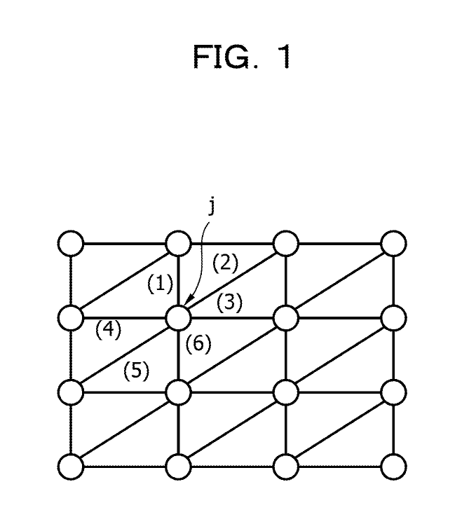

First, before describing examples of a memory control apparatus and a memory control method, an example of a finite element method application, an example of a memory device, and problems thereof will be described with reference to FIG. 1 to FIG. 3.

FIG. 1 is a diagram for explaining an example of a process of triangle element division in the finite element method application. As described above, for example, in the finite element method application targeting tens of millions of elements, calculation is executed by holding array data (large-scale array data) in the memory device. In a case of speeding up by an accelerator (hardware accelerator), reading and writing of the array data are major factors affecting performance.

In a finite element method, an overall stiffness matrix is constructed based on an element stiffness matrix defined for each element. For example, as illustrated in FIG. 1, in a case of the triangle element division, a coefficient of an overall stiffness matrix corresponding to a node j is a total value of coefficients of element stiffness matrices of adjacent elements (1) to (6).

If a coefficient of an overall stiffness matrix is successively updated every time the element stiffness matrix is constructed, six writings occur in total for the coefficient of one node (j). In addition, for example, in a case of a non-linear finite element method, since the coefficient of the overall stiffness matrix is to be updated repeatedly, reducing a writing time is important.

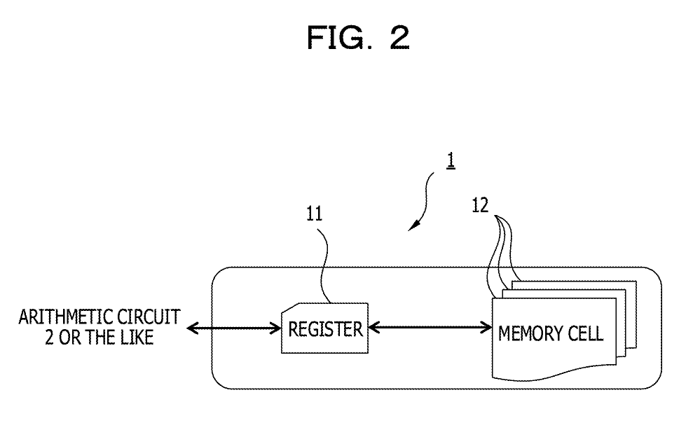

FIG. 2 is a diagram schematically illustrating an example of the memory device. As illustrated in FIG. 2, a memory device 1 includes a register 11 and memory cells 12. For example, the memory device 1 is a large-scale storage device such as a dynamic random access memory (DRAM) (for example, synchronous DRAM (SDRAM)), a flash memory, and a hard disk (hard disk drive).

In the memory device 1, for example, data is copied by blocks from a memory cell 12 to the register 11, furthermore, data corresponding to a bus width is exchanged with an external arithmetic circuit 2 or the like via the register 11. In addition, in the memory device 1, data from the arithmetic circuit 2 or the like is written into the memory cell 12 via the register 11.

For example, a large-scale storage device (memory device 1) such as the DRAM, the flash memory, and the hard disk has a block access function for executing reading and writing of data by blocks. In the memory device 1 having the block access function, for example, block access to the consecutive addresses of the memory cells 12 has much higher throughput than random accessing.

For example, the memory device 1 is considered to be a double-data-rate SDRAM (DDR SDRAM) that has a specification of, for example, 64-byte width, latency of random accessing is 16 μs and throughput of the block accessing is 4 GB/s.

In a case where the memory device 1 is completely randomly accessed, when throughput of the random accessing=64 bytes/16 μs=4 MB/s is satisfied, the throughput of the block accessing (4 GB/s) is 1,000 times higher than that of the random accessing.

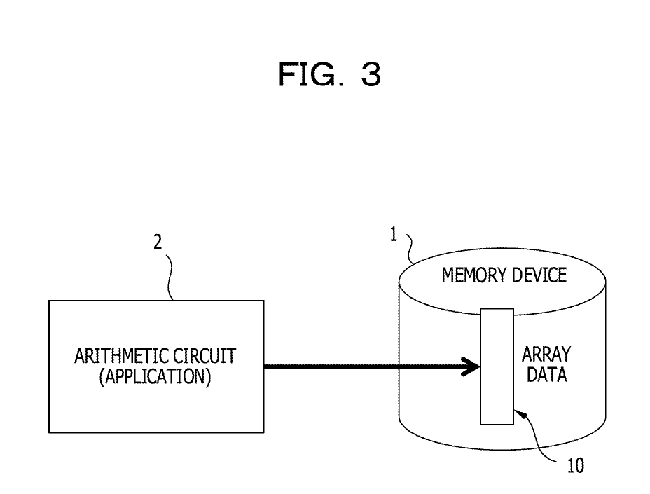

FIG. 3 is a diagram for explaining a problem in the memory device illustrated in FIG. 2. For example, the arithmetic circuit 2 is considered to execute an application for writing large-scale array data (array data) to the memory device 1 such as the DRAM and the flash memory.

Access to array data 10 stored in the memory device 1 by the application is executed in an any order according to an algorithm held by the application. For example, in a case where arithmetic circuits 2 are parallelized, simultaneous access to different elements of the array in the array data 10 may also occur.

When viewed this from the memory device 1, a great amount of random access writing occurs, which causes deterioration in performance as an application. For example, in construction of the overall stiffness matrix in the application of the above-described finite element method, the random accessing is executed in coefficient updating for each element stiffness matrix, which may cause performance deterioration.

As described above, by using methods such as write combining and sparse matrix/tiling, a method of writing array data at high speed is proposed, however, the write combining has a problem that a probability of combining decreases as the array data becomes larger. In addition, the sparse matrix/tiling is not suitable for, for example, random access writing because an array itself that collects non-zero coefficients becomes a dense matrix.

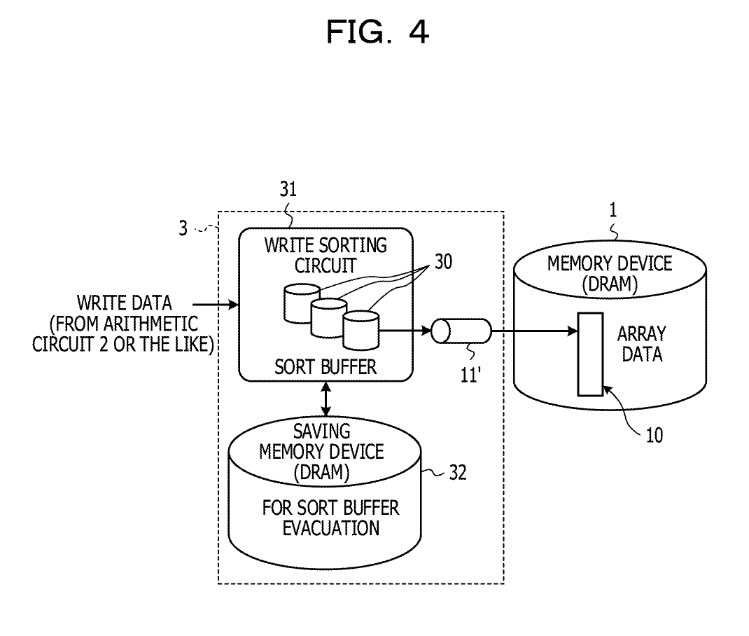

Hereinafter, examples of the memory control apparatus and the memory control method will be described in detail with reference to the drawings. FIG. 4 is a diagram schematically illustrating the memory control apparatus according to an embodiment. As illustrated in FIG. 4, for example, a memory control apparatus 3 of the present embodiment controls writing of data (data to be written) from the arithmetic circuit 2 (application) to the memory device 1 that is a large amount memory of the DRAM or the like.

For example, the memory control apparatus 3 includes a write sorting circuit 31 including a sort buffer 30, a saving memory device 32 such as the DRAM, and a write buffer 11′. As the write buffer 11′, for example, the register 11 in the memory device 1 described with reference to FIG. 2 may be used without providing a dedicated buffer. In addition, the memory device 1 has the block access function.

As illustrated in FIG. 4, the memory control apparatus 3 (write sorting circuit 31) receives a plurality of data to be written (array data) as input, and writes the data to the memory device 1 by using the block access function via the write buffer 11′. For example, the memory control apparatus 3 may include a direct memory access (DMA) circuit having the block access function.

For example, the array data may be represented by a set (index and value) of an index of an array element and values to be written into the element. In addition, the write sorting circuit 31 includes a plurality of the sort buffers 30, and is connected to the saving memory device 32 for saving a content of, for example, the sort buffer 30. For example, the saving memory device 32 is a device for temporarily saving data stored in the sort buffer 30.

The write buffer 11′ receives array data (data to be written) from the sort buffer 30, and executes, for example, rewriting (writing) of the array data 10 in the memory device 1. As the memory device 1, for example, the DRAM (for example, SDRAM), the flash memory, the hard disk, or the like including the block access function may be applied.

As the saving memory device 32, for example, the DRAM or the like having a capacity (storage capacity) greater than that of data received by the write sorting circuit 31 may be applied. The above-described write sorting circuit 31 is not limited one, and it is needless to say that a plurality of (for example, four or eight) circuits may be provided.

As described above, in the memory control apparatus of the present embodiment, when writing array data (data to be written) into the memory device 1 having the block access function, the array data are sorted in a plurality of the sort buffers 30. Furthermore, the array data sorted in the sort buffers 30 are written into the memory device 1 by using the block access function. With this, it is possible to collectively execute the writing of the array data into the memory device 1 by using the block access function, and it is possible to further increase speed.

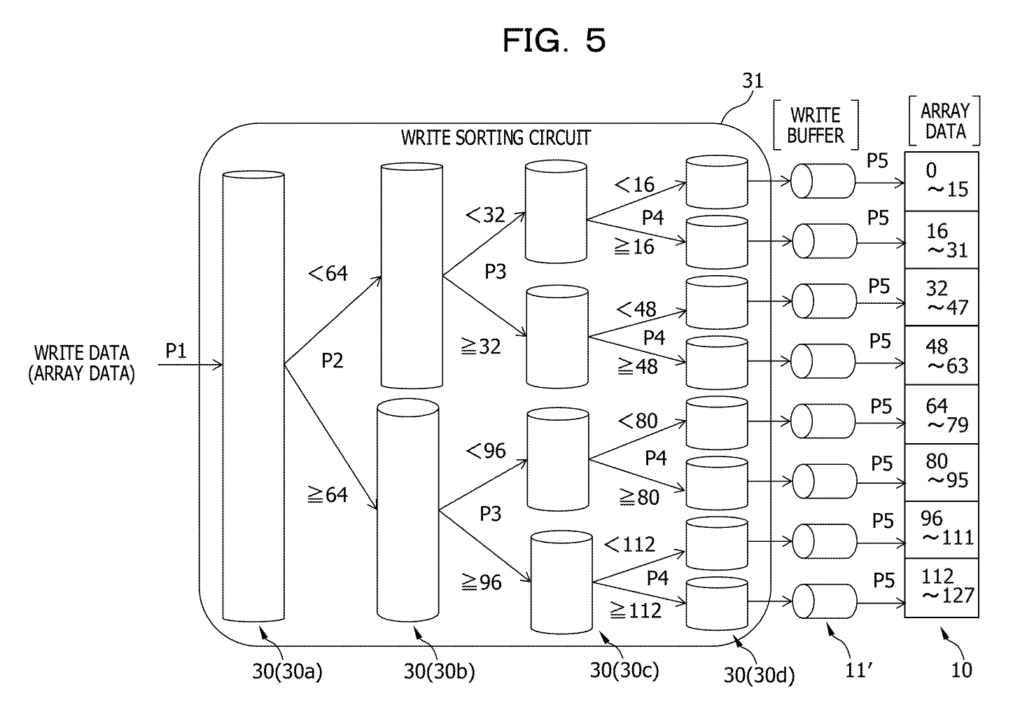

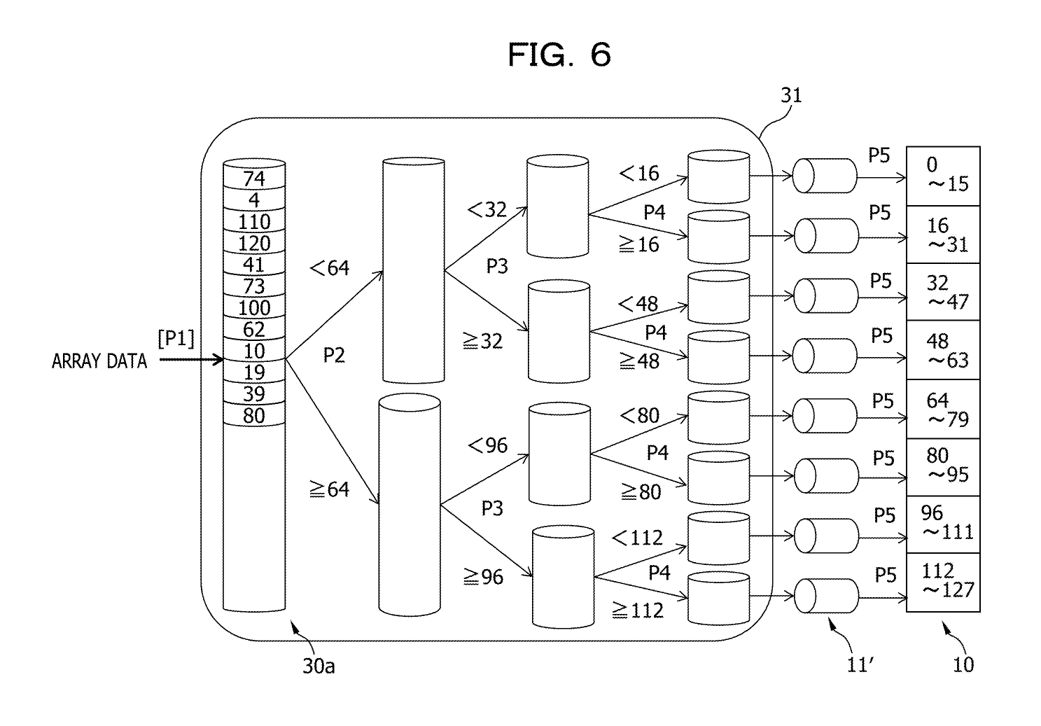

FIG. 5 is a diagram for explaining an example of the memory control apparatus, FIG. 6 to FIG. 10 are diagrams for explaining examples of algorithm operations in the memory control apparatus of the example illustrated in FIG. 5. Here, for example, the data to be written (array data) from the arithmetic circuit 2 or the like is explained as a block size M=16 elements and the number of elements of the array data N=128.

As illustrated in FIG. 5, in the memory control apparatus of an example, an operation order is an order of an input process (process [P1]) of the entirety of the array data, radix sort processes (process [P2] to process [P4]) of the array data, and an update process (processes [P5]) of the array data.

The process P1 to the process P5 will be described with reference to FIG. 6 to FIG. 10. As seen from the comparison with a case of FIG. 4 described above, the saving memory device 32 is omitted in FIG. 5, and FIG. 6 to FIG. 10. In addition, the write buffer 11′ may use the register 11 in the memory device 1 as described above without providing a dedicated buffer.

First, as illustrated in FIG. 6, in the input process [P1] of the entirety of the array data, the write sorting circuit 31 receives the entirety of the array data (data to be written), and stores the received array data in a 0-th stage sort buffer (buffer) 30a in radix sorting. In this example, the number of the array data is 12 (here, numbers 74, 4, 110, 120, 41, . . . in buffer 30a of FIG. 6 represent indexes of array data of write destination).

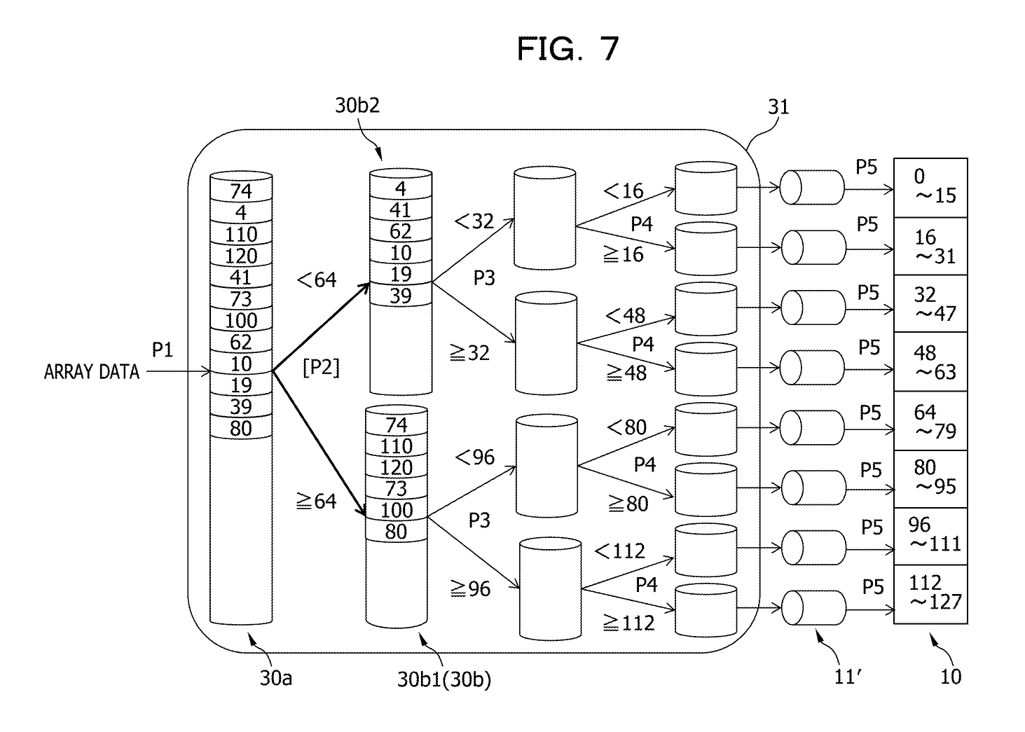

Next, as illustrated in FIG. 7, in the radix sort process [P2] of the array data, by sequentially reading the data stored in the 0-th stage buffer 30a, for example, according to whether the index is equal to or greater than 64 (index≥64) or not (index<64), the data is distributed to a first stage buffer 30b1 or 30b2. For example, in an example of FIG. 7, six pieces of array data (indexes 74, 110, 120, 73, 100, and 80) of 64≤index are stored in the first stage buffer 30b1, and six pieces of array data (indexes 4, 41, 62, 10, 19, and 39) of an index<64 are stored in the first stage buffer 30b2.

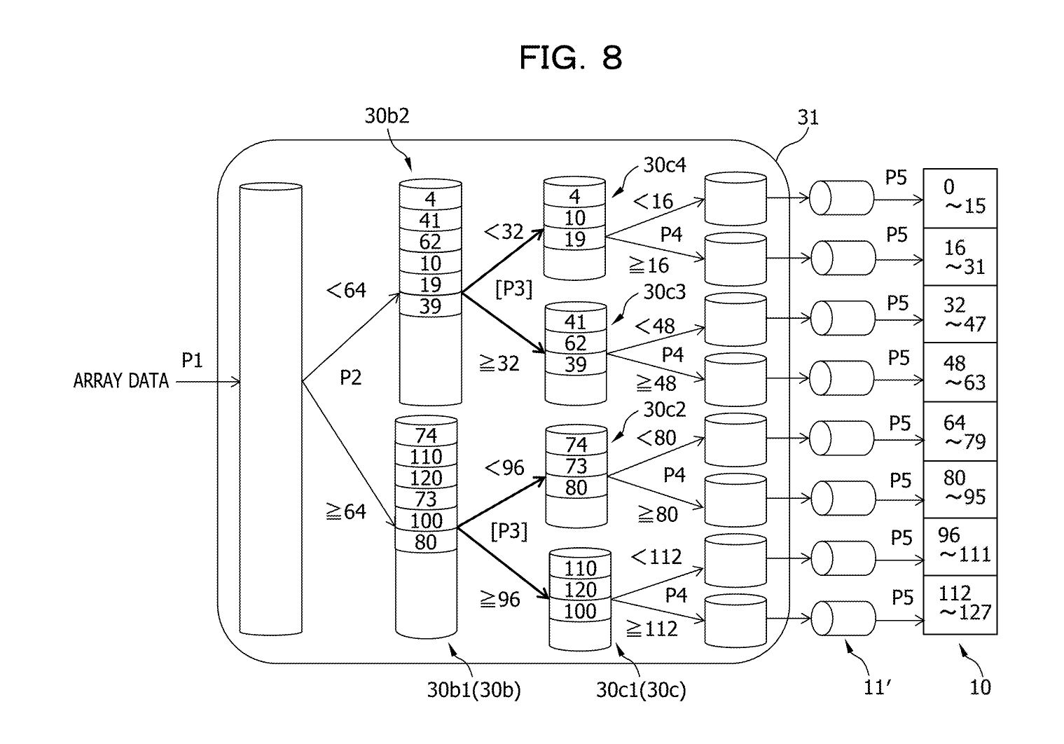

As illustrated in FIG. 8, in the radix sort process [P3] of the array data, by sequentially reading the data stored in the first stage buffer 30b1, for example, according to whether the index is equal to or greater than 96 or not, the data is distributed to a second stage buffer 30c1 or 30c2. In addition, by sequentially reading the data stored in the first stage buffer 30b2, for example, according to whether the index is equal to or greater than 32 or not, the data is distributed to a second stage buffer 30c3 or 30c4.

For example, in an example of FIG. 8, three pieces of array data (indexes 110, 120, and 100) of 96≤index are stored in the buffer 30c1, three pieces of array data (indexes 74, 73, and 80) of 64≤index<96 are stored in the buffer 30c2. In addition, three pieces of array data (indexes 41, 62, and 39) of 32≤index<64 are stored in the buffer 30c3, and three pieces of array data (indexes 4, 10, and 19) of index<32 are stored in the buffer 30c4.

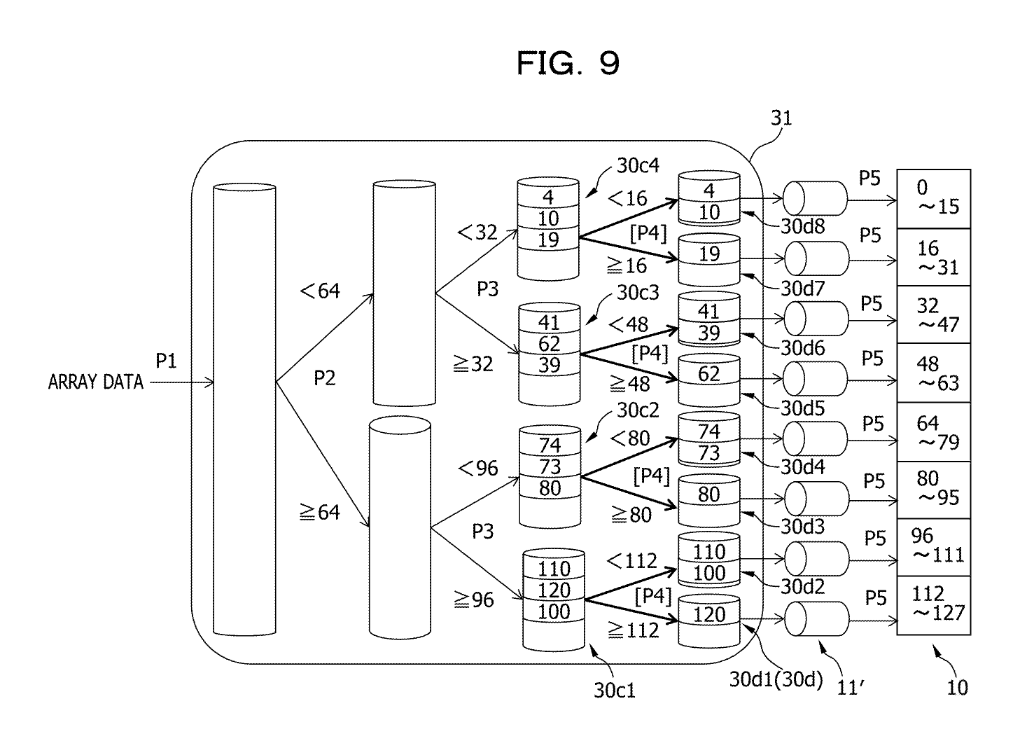

As illustrated in FIG. 9, in the radix sort process [P4] of the array data, by sequentially reading the data stored in the second stage buffer 30c1, for example, according to whether the index is equal to or greater than 112 or not, the data is distributed to a third stage buffer 30d1 or 30d2. In addition, by sequentially reading data stored in the second stage buffer 30c2, for example, according to whether the index is equal to or greater than 80 or not, the data is distributed to the third stage buffer 30d3 or 30d4.

By sequentially reading data stored in the second stage buffer 30c3, for example, according to whether the index is equal to or greater than 48 or not, the data is distributed to a third stage buffer 30d5 or 30d6. In addition, by sequentially reading data stored in the second stage buffer 30c4, for example, according to whether the index is equal to or greater than 16 or not, the data is distributed to a third stage buffer 30d7 or 30d8. In this example, for example, because of log₂(N/M)=log₂(128/16)=3, the radix sorting completes in the process [P4] of the third stage.

For example, in an example of FIG. 9, one piece of array data (index 120) of 112≤index is stored in the buffer 30d1, and two pieces of array data (indexes 110 and 100) of 96≤index<112 are stored in the buffer 30d2. One piece of array data (index 80) of 80≤index<96 is stored in the buffer 30d3, and two pieces of array data (indexes 74 and 73) of 64≤index<80 is stored in the buffer 30d4.

Furthermore, one piece of array data (index 62) of 48≤index<64 is stored in the buffer 30d5, and two pieces of array data (indexes 41 and 39) of 32≤index<48 are stored in the buffer 30d6. One piece of array data (index 19) of 16≤index<32 is stored in the buffer 30d7, and two pieces of array data (indexes 4 and 10) of index<16 are stored in the buffer 30d8.

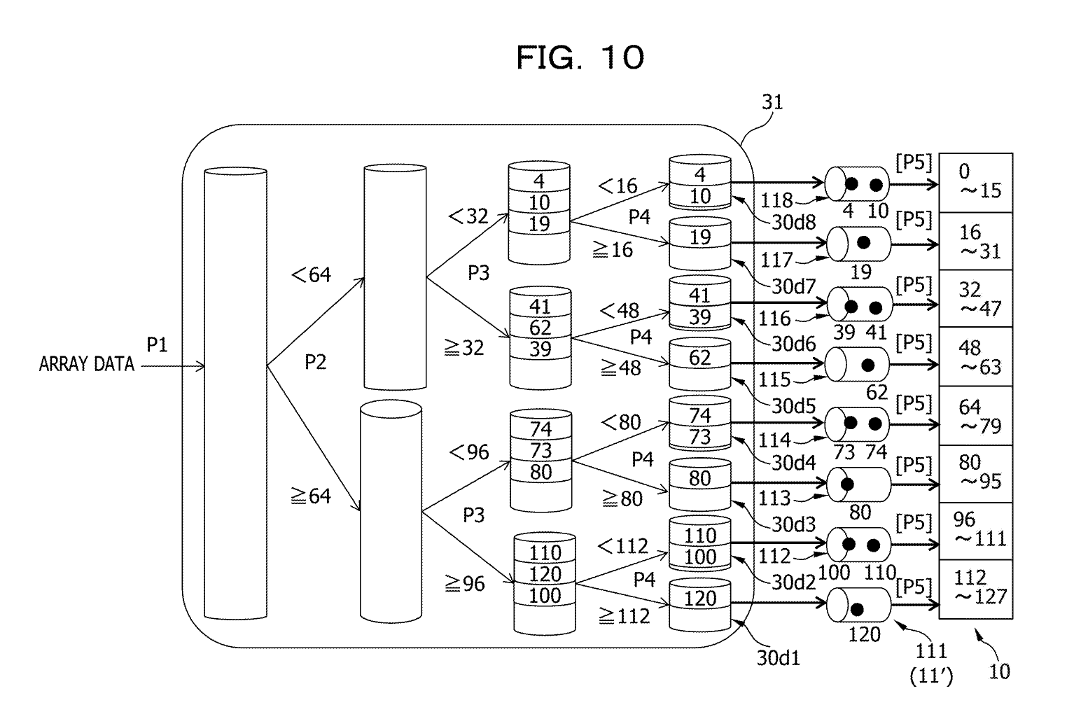

As illustrated in FIG. 10, in the update process [P5] of the array data, the array data within the third stage sort buffers 30d (30d1 to 30d8) are reflected in the write buffer 11′ (111 to 118). For example, the array data (data to be written) sorted in the buffers 30d1 to 30d8 are sent to write buffers (registers) 111 to 118, and the array data 10 of the memory device 1 are rewritten collectively by using the block access function.

For example, if there are a plurality of array data for the same index, the plurality of array data is processed here. For example, a process is executed in which if an array update method is in an overwrite mode, any one of write values is selected, and if the mode is in an integration mode, the sum of all write values is calculated.

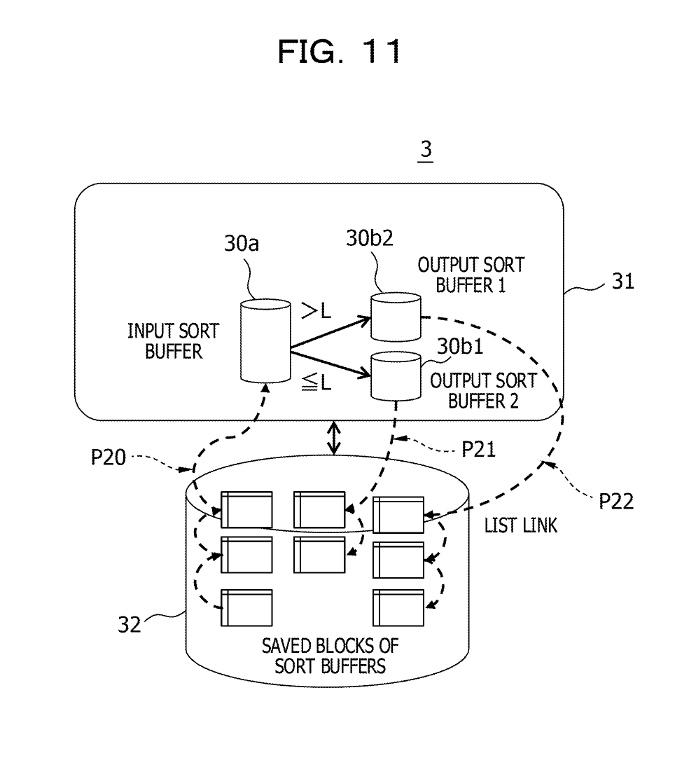

FIG. 11 is a diagram for explaining an example of a distribution process in the memory control apparatus in the example illustrated in FIG. 5. As illustrated in FIG. 11 and the above-described FIG. 4, the memory control apparatus 3 of an example includes the write sorting circuit 31 and the saving memory device 32.

FIG. 11 illustrates a process in a case where, for example, the data is distributed from one buffer (sort buffer) to two buffers in the radix sorting. For example, the case corresponds to a case where data stored in one 0-th stage buffer (input sort buffer) 30a is distributed to two first stage buffers (output sort buffers) 30b1 and 30b2 in the process [P2] described with reference to FIG. 7. At this time, a threshold L becomes the index 64.

The case corresponds to a case where data stored in one first stage buffer 30b1 is distributed to two second stage buffers 30c1 and 30c2 in the process [P3] described with reference to FIG. 8. At this time, the threshold L becomes the index 96. Furthermore, the case corresponds to a case where data stored in one first stage buffer 30b2 is distributed to two second stage buffers 30c3 and 30c4 in the process [P3]. At this time, the threshold L becomes the index 32. This is similar to a case in the process [P4] described with reference to FIG. 9.

As described above, in the radix sorting, the data to be written (array data) is fetched from one input sort buffer (for example, 30a), and depending on whether or not index is equal to or greater than L (for example, 64), the fetched data to be written is stored in one of two output sort buffers (for example, 30b1 and 30b2).

In a case where an amount of data exceeds a buffer capacity, for example, as illustrated in P21 and P22 of FIG. 11, the data exceeding the buffer capacity is listed as a saved block and saved in the saving memory device 32. As the saving memory device 32, for example, the DRAM (SDRAM) may be applied thereto.

For example, if space is found in the buffer 30a (for example, buffer 30a becomes empty), the saved block is read from the saving memory device 32 by tracing a list, and recovered (supplementation: P20 in FIG. 11) by the block access to the buffer 30a. As described above, the write sorting circuit 31 also has a function as a circuit for distributing data, and, for example, if the output sort buffers (30b1 and 30b2) become full, overflowed data is saved in the saving memory device 32 by the block accessing, and inserted into the list.

As described above, because updating of the array data 10 stored in the memory device 1 may be executed by using the block access function and writing a plurality of elements within the same block, it is possible to greatly decrease a time as compared with the case of random accessing. For example, when the amount of the array data written into the memory device 1 is equal to or greater than a predetermined threshold, it is possible to execute writing by the above-described block access to the memory device 1, and when the amount of the array data is smaller than the predetermined threshold, it is possible to execute the writing by the random accessing.

For example, the distribution process for each stage buffer of the radix sorting may be executed by three sort buffers, for example, one input sort buffer and two output sort buffers in a case of the examples described with reference to FIG. 5 to FIG. 10. Furthermore, for example, the sort buffer (buffer) is formed with a first-in-first-out (FIFO) register and data overflowed from the FIFO register is saved in the saving memory device 32, and therefore there is practically no limit on the number of pieces of data. In addition, by using the block accessing for saving (recovering) data to the saving memory device 32, a time requested for the radix sorting does not become a problem (which will be described below in detail).

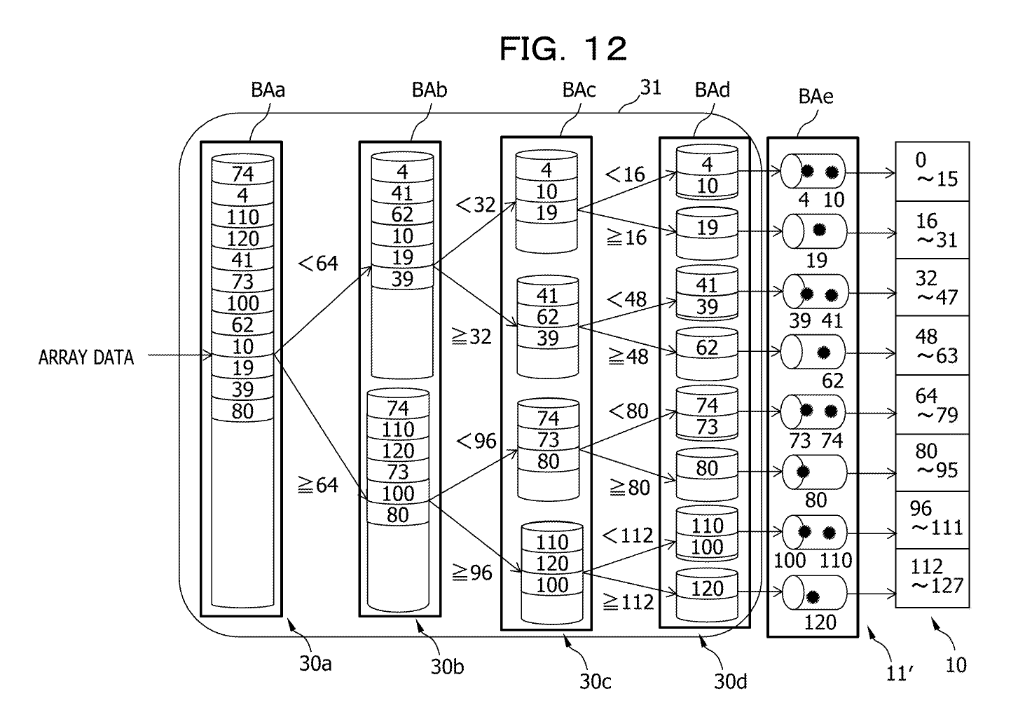

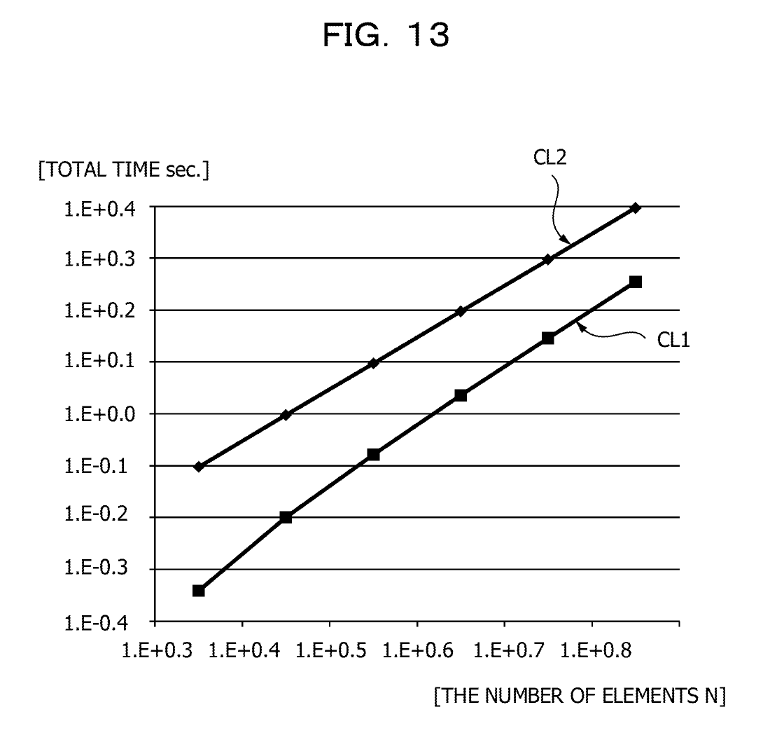

FIG. 12 and FIG. 13 are diagrams for explaining effect due to the memory control apparatus of an example. As illustrated in FIG. 12, for example, in a case of the example described with reference to FIG. 5 to FIG. 10, the block accessing is executed at saving and recovering of the data to be written (array data) at each stage of the radix sorting and at writing from the write buffer 11′ to the array data 10 of the memory device 1.

When the throughput of the random accessing and the throughput of the block accessing are considered as 64 k elements/s and 64 M elements/s, respectively, and the block size M=256 elements is considered, the memory capacity and a processing time requested for updating all the array data K times are estimated.

In the memory control apparatus of the above-described embodiment, since the data to be written of K×N are saved (recovered) in the saving memory device 32 in the worst case at each stage of the radix sorting, the storage capacity is provided for 2×K×N elements. This storage capacity is suppressed to a multiple of the number of elements N at most. Furthermore, the number of accesses to the memory device is 2×K×N times in the worst case for each stage of the radix sorting, and writing to the array data 10 is executed once for each block in the final stage.

Memory accessing may be realized by the block accessing and the number of stages of the radix sorting is log₂(N/M), and therefore the total time by the above-described memory control apparatus of an embodiment is as follows.

$$\begin{matrix}Total time of the present embodiment = & ( 1 \text{/} 64 \text{,} 000 \text{,} 000 ) \times \\ & \{ ( 2 \times K \times N ) \times \\ & {log}_{2} ( N \text{/} M ) + N \} \\ ≅ & ( 1 \text{/} 32 \text{,} 000 \text{,} 000 ) \times \\ & {log}_{2} ( N \text{/} 256 ) \times ( K \times N )\end{matrix}$$

On the other hand, for example, when considering the memory control apparatus executing the random accessing, updating is performed K×N times, the total time is as follows.

Total time of the random accessing=(1/64,000)×(K×N)

Accordingly, when comparing the total time {(1/32,000,000)×log₂ (N/256)×(K×N)} by the memory control apparatus of the present embodiment with the total time {(1/64,000)×(K×N)} of the random accessing, the coefficient for N is very small in the present embodiment due to the block accessing. Therefore, it is understood that it is possible to increase speed.

For example, in a case where the entirety of array data is updated six times (array data 10 in memory device 1 is rewritten six times), K is six. It is assumed that the throughput of the present embodiment is “64 M elements/s”, and the throughput of the random accessing is “64 k elements/s”. These values are values that may be assumed.

Furthermore, when it is assumed that the block size M is 256 elements and the number of update operations K is six, a relationship between the total time by the memory control apparatus and the number of elements N is as illustrated in FIG. 13. In addition, in FIG. 13, a reference sign CL1 indicates a characteristic curve by the memory control apparatus of the present embodiment and a reference sign CL2 indicates a characteristic curve by the random accessing.

As is apparent from the comparison between the characteristic curves CL1 and CL2 in FIG. 13, for example, in a case of K=six, a characteristic curve CL1 by the memory control apparatus of the present embodiment may be speeded up to nearly two digit orders of magnitude higher than the characteristic curve CL2 by the random accessing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A memory control apparatus comprising:
at least one buffer memory; and
a processor coupled to the at least one buffer memory, and the processor configured to execute a process including:
receiving pieces of data to be written to a memory device, each of the pieces of data being associated with an index indicating a position of memory region of in the memory device;
storing the pieces of data to the at least one buffer memory;
sorting the pieces of data stored in the at least one buffer memory in accordance with the index;
write the pieces of data sorted in the at least one buffer memory to the memory device at once, by using a block access function that writes plural pieces of data each of which the position indicated by the index is included in the predetermined index range.

2. The memory control apparatus according to claim 1, wherein
the at least one buffer memory is a plurality of buffer memories having a hierarchical structure.

3. The memory control apparatus according to claim 1, wherein
the sorting sorts the pieces of data by using radix sorting.

4. The memory control apparatus according to claim 3, wherein the process further includes:
generating, based on the array data sorted in the at least one buffer memory, a content of write data by blocks; and
writing the write data to the memory device by using the block access function.

5. The memory control apparatus according to claim 1, further comprising:
a saving memory that saves data exceeding a capacity of the at least one buffer memory by using the block access function.

6. The memory control apparatus according to claim 1, further comprising:
a write buffer memory that holds the pieces of sorted data sorted by the sorting; and wherein
the writing writes the pieces of sorted data, held in the write buffer memory, to the memory device by using the block access function.

7. The memory control apparatus according to claim 6, wherein
the write buffer memory uses a register provided in the memory device.

8. The memory control apparatus according to claim 1, wherein the writing:
writes the pieces of data by using the block access function when an amount of the pieces of data to be written to the memory device is equal to or greater than a predetermined threshold; and
writes the pieces of data by random access when the amount of the pieces of data to be written to the memory device is smaller than the predetermined threshold.

9. The memory control apparatus according to claim 1, wherein
the memory device includes at least one of a dynamic random access memory (DRAM) device, a flash memory device, and a hard disk device.

10. A memory control method executed by a computer, the memory control method comprising:
receiving pieces of data to be written to a memory device, each of the pieces of data being associated with an index indicating a position of memory region of in the memory device;
storing the pieces of data to at least one buffer memory;
sorting the pieces of data stored in the at least one buffer memory in accordance with the index;
write the pieces of data sorted in the at least one buffer memory to the memory device at once, by using a block access function that writes plural pieces of data each of which the position indicated by the index is included in the predetermined index range.

11. The memory control method according to claim 10, wherein
the at least one buffer memory is a plurality of buffer memories having a hierarchical structure.

12. The memory control method according to claim 10, wherein
the sorting sorts the pieces of data by using radix sorting.

13. The memory control method according to claim 12, further comprising:
generating, based on the array data sorted in the at least one buffer memory, a content of write data by blocks; and
writing the write data to the memory device by using the block access function.

14. The memory control method according to claim 10, wherein
the computer includes a saving memory that saves data exceeding a capacity of the at least one buffer memory by using the block access function.

15. The memory control method according to claim 10, wherein
the computer includes a write buffer memory that holds the pieces of sorted data sorted by the sorting; and wherein
the writing writes the pieces of sorted data, held in the write buffer memory, to the memory device by using the block access function.

16. The memory control method according to claim 15, wherein
the write buffer memory uses a register provided in the memory device.

17. The memory control method according to claim 10, wherein the writing:
writes the pieces of data by using the block access function when an amount of the pieces of data to be written to the memory device is equal to or greater than a predetermined threshold; and
writes the pieces of data by random access when the amount of the pieces of data to be written to the memory device is smaller than the predetermined threshold.

18. The memory control method according to claim 10, wherein
the memory device includes at least one of a dynamic random access memory (DRAM) device, a flash memory device, and a hard disk device.
